(19) United States
(12) Patent Application Publication
(10) Pub. No.: US 2008/0099516 A1
(43) Pub. Date: May 1, 2008

(54) Extended discharge tube for total release actuators

(76) Inventor: Brian O. LaCoste, Shreveport, LA (US)

Correspondence Address: Brian O. LaCoste, 7426 Matterhorn Dr., Shreveport, LA, 71107, US

(21) Appl. No.: 11/589,644

(22) Filed: Oct. 31, 2006

(51) Int. Cl. B67D 3/00

(52) U.S. Cl. 222/527

(57) ABSTRACT

The invention disclosed herein relates to a flexible extended discharge tube for known total release aerosol insecticidal fogger designs, which provides a means for effective remote application of the insecticide to enclosed air spaces without requiring alteration to the existing enclosure of the space. An improved total release actuator affords the user the option of either applying the fogger in its conventional manner or utilizing the apparatus in conjunction with the extended discharge tube. The adapted total release actuator contains a congruently molded shape that readily accepts a mating end of the extended discharge tube. Radial disposed barbs near the discharge end of the discharge tube are flexible enough to fold axially along the discharge tube for easy insertion into narrow crevices, yet resilient enough to support the suspended weight of a fully charged aerosol canister. All portions of the extended discharge tube, as well as its connections to the total release actuator are robust enough to withstand axial loading associated with supporting a fully charged aerosol canister during injection of a stream of high pressure mist.

### FIELD OF THE INVENTION

Various devices commonly referred to as total release actuators for aerosol canisters have been previously established as effective. These apparatuses provide means for attachment of the device to a standard aerosol can with centrally located valve stem and having a means of releasing contents of the can by either tilting the valve stem side to side or depressing the stem directly inward. Total release actuators, as a basic premise, lock the valve stem in the actuated position to ensure that the pressurized contents of the can are completely evacuated in a single burst without requiring the user to continually depress the discharge trigger. Prior art regarding total release aerosol fogger type actuators incorporates an orifice, which atomizes the pressurized liquid contents upon discharge to create a mist or fog. Insecticidal products applied by this fogging approach are known and are very effective in extermination of various types of insects and spiders. However, conventional insecticidal foggers are restrictive by their general nature in that the aerosol container and actuator assembly must be physically placed within the target space intended to receive the fog.

The present invention provides for a modification to existing aerosol fogger designs, which will afford the user the option to either apply the device in its conventional fashion, which is placing the can in a room, actuating the trigger and exiting the room, or by attaching a specially designed extended discharge tube to that same total release actuator, and injecting the insecticidal fog directly into areas not accessible by a window, door or other sealable entrance way.

By their nature insects such as roaches, hornets, bees, wasps, etc., as well as spiders, prefer to nest in areas which minimize the chance of disturbance by weather, predators or humans. Insects and spiders located under the eves or within open corners of buildings can be easily exterminated by conventional spray insecticide. However, many times these nesting areas are in confined spaces not easily accessible by humans. Some of these areas include, but are not limited to, the interior of eves or dormers of a house, under the hood of a car, beneath the cover of an outboard motor, or in a hole deep underground. However, for obvious reasons nesting areas must always have some means of access and egress by the pest. Though these small holes or crevices are large enough to allow the pest to enter they are rarely large enough to allow the proper application of spray insecticides to the nest. The present invention utilizes the entrance hole to the nest as a portal to apply insecticidal fog to the enclosed space thereby exterminating the pest and killing the nest.

Prior art is established for remotely spraying mists or fogs into enclosed spaces. However, existing designs require puncturing the wall of the enclosed space to provide a portal to apply the spray. Most of these designs serve the purpose of extinguishing fires. Though drilling or piercing holes into ones house or other property may be deemed acceptable to quench a fire or kill termites, there are many instances where this approach would be considered too extreme for normal insect extermination. The processes required by the prior art not only necessitate damage to property, but they can also be hazardous to the person required to drill a hole in the structure. For example the vibration necessary to create a hole near a wasp or hornet nest will normally alert the nest and send swarms of angry insects for an attack.

Converse to prior art, the present invention allows the discharge end of a flexible discharge tube to be gently inserted into the existing entrance hole or crevice without damage or alteration of the enclosed space. At least one radially disposed protrusion or barb is located near the discharge end of the discharge tube and is flexible enough to fold axially along the tube, which allows the tube to be easily inserted into the pest's entrance hole. Once within the space these flexible members spring out radially and are resilient enough to support the entire weight of the aerosol canister, thus allowing the canister to be suspended beneath the entrance hole in proper upright position to ensure full evacuation of pressurized contents. After the container has been fully discharged and the hazard of flying pests have been eliminated, the apparatus is removed by pulling on the discharge tube until the flexible barb(s) fold axially in the opposite direction as before. This procedure allows the apparatus to be easily removed and properly disposed of.

Other art exists which provides a means of attachment of extended tubes to aerosol trigger mechanisms. However, the present design provides a more robust means of attachment that securely holds the tube in place. This is significant due to the additional axial loading associated with suspending the canister's weight via the tube in addition to the conventional thrust loads produced by expelling a pressurized spray through a narrow tube. Acceptable means of attachment are opposing barbs, opposing contours or threads, though other proven attachment processes may be applicable.

An additional benefit of the disclosed invention over prior art is the ability to direct the fog to a downward location while maintaining the canister in upright attitude to facilitate full evacuation of pressurized contents. Insects that nest in holes underground are difficult to kill due to limited access for application of spray insecticide directly to the nest. The novel design of the extended discharge tube of the preferred embodiment allows the aerosol canister to rest upright on its base while the extended tube is utilized to inject insecticidal fog downward into a nest entrance hole in the ground. By sealing around the discharge tube with dirt, a cloth, or other means, complete extermination of nests deep underground can be achieved.

Experiments indicate that the best times for insecticidal fogging of enclosed spaces, especially with regards to flying insects such as wasps or hornets, is during rainy or cold weather or after dark. During these times the majority of the insects will be at the nest and least active, thereby ensuring the most pests are killed with the least chance of alerting the nest.

The result of the disclosed device and its application process provides an effective local application of the insecticidal fog that will, almost immediately, kill all pest in the space, thus rendering the nest dormant without any damage or alteration to the enclosure of the confined space. Additionally the preferred embodiment of the invention provides the user with a choice of either orthodox utilization of the device as a traditional aerosol total release fogger or utilization of the extended discharge tube for injection of the fog into a confined space as set forth above.

### BRIEF SUMMARY OF THE INVENTION

A modification to existing total release actuators normally used in conjunction with aerosol containers charged with insecticide to generate and apply insecticidal fog in a single burst rather than several individual burst. This adaptation of the existing art incorporates a means for attachment of an extended discharge tube used to inject insecticidal fog to the interior of a difficult to access space. The extended discharge tube is comprised of a flexible tubular member, having an internal passage, an attachment end and a discharge end. The extended discharge tube is flexible yet resilient enough to be inserted into tight crevices and around corners. The attachment end provides a means of securely locking or screwing the discharge tube into a mating shape on the actuator cap so as to provide a continuous passage therewith. The discharge end is equipped with at least one flexible protrusion or barb which extends radially away from the exterior of the tube. The barb(s) are pliable enough to allow insertion and withdrawal of the discharge end of the discharge tube within a small crevice or port in the enclosed space, yet resilient enough to support the weight of a fully charged aerosol can. The design disclosed is economical to build, safe to use, and has proven to be very effective without damage to existing property where it is utilized.

### BRIEF DESCRIPTION OF THE DRAWINGS

FIG. 1 is a cross-sectional view of a preferred embodiment of the invention taken along the centerline of the total release actuator and extended discharge tube.

FIG. 2 is a rear elevation view of the embodiment illustrated in FIG. 1.

FIG. 3 is a side elevation view of the embodiment illustrated in FIG. 1.

FIG. 4 is a cross-sectional view of the embodiment illustrated in FIG. 1 taken along centerline of the total release actuator and extended discharge tube, depicting a typical application of the apparatus, consisting of said embodiment being used to inject the contents of an aerosol container into an eve of a house enclosed with vinyl siding.

FIG. 5 is a side plan view of a preferred embodiment of the extended discharge tube, shown separate from the total release actuator portion of the invention.

FIG. 6 is a bottom plan view of the extended discharge tube illustrated in FIG. 5.

FIG. 7 is a fragmentary sectional view partly in side plan view depicting a portion of the extended discharge tube illustrated in FIG. 5.

FIG. 8 is a side plan view of an alternate embodiment of the extended discharge tube, shown separate from the total release actuator portion of the invention.

FIG. 9 is a bottom plan view of the extended discharge tube illustrated in FIG. 8.

FIG. 10 is a fragmentary sectional view of a second alternate embodiment of the extended discharge tube and associated mating portion of the total release actuator, taken along the longitudinal axis of the invention, shown first as disconnected from one another and then attached together as an assembly.

FIG. 11 is a fragmentary sectional view of a third alternate embodiment of the extended discharge tube and associated mating portion of the total release actuator, taken along the longitudinal axis of the invention, shown first as disconnected from one another and then attached together as an assembly.

FIG. 12 is a fragmentary sectional view of a fourth alternate embodiment of the extended discharge tube and associated mating portion of the total release actuator, taken along the longitudinal axis of the invention, shown first as disconnected from one another and then attached together as an assembly.

### DETAILED DESCRIPTION OF THE INVENTION

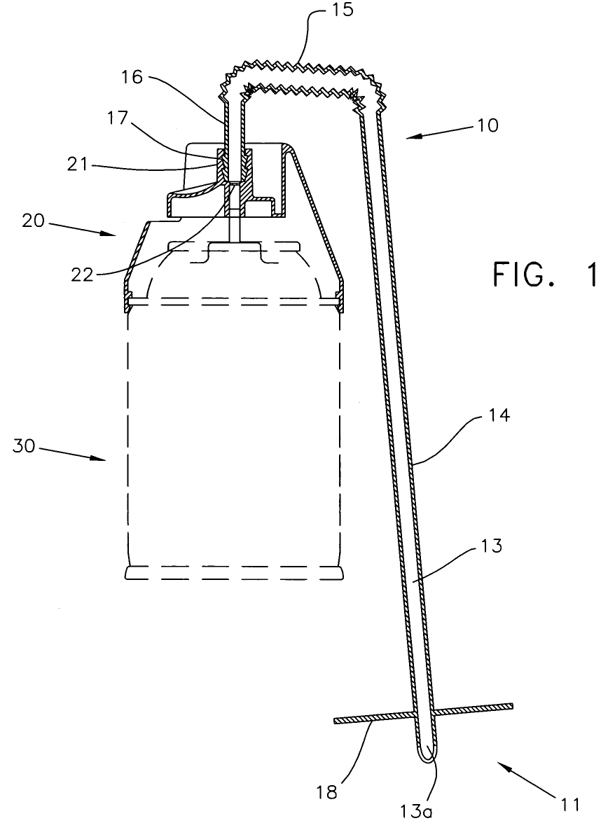

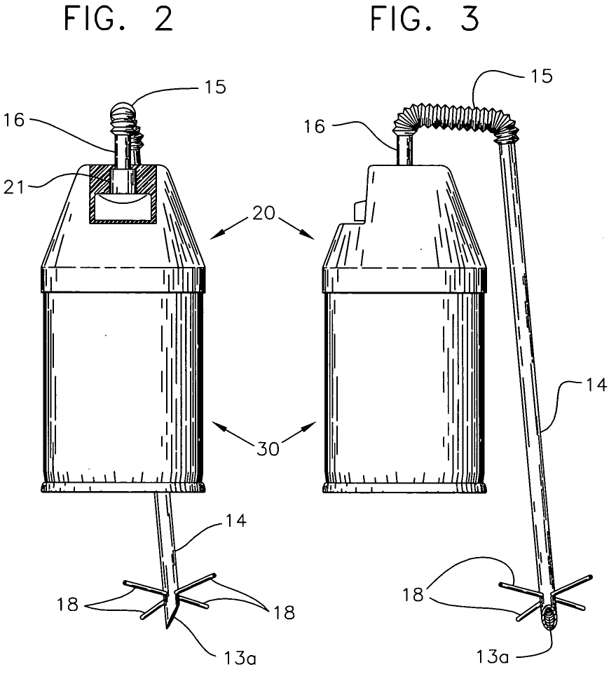

Turning now to the drawings, wherein like parts are indicated by reference numbers. FIGS. 1, 2, and 3 show the preferred embodiment of the invention. The primary device is an extended discharge tube, shown generally at 10, consisting of a single piece elongated member containing a hollow cavity 13 throughout its entire length and having an attachment end 12, proximal tubular portion 16, a corrugated portion 15, a distal tubular portion 14, and a discharge end 11. Additionally this inventive design provides for an improvement to known aerosol total release actuators, shown generally at 20, which securely accepts the attachment end 12 of said elongated discharge tube 10, while positioning the hollow cavity 13 laterally above the discharge orifice 22 of the actuator in a manner which allows effective conventional utilization of the total release actuator's trigger mechanism.

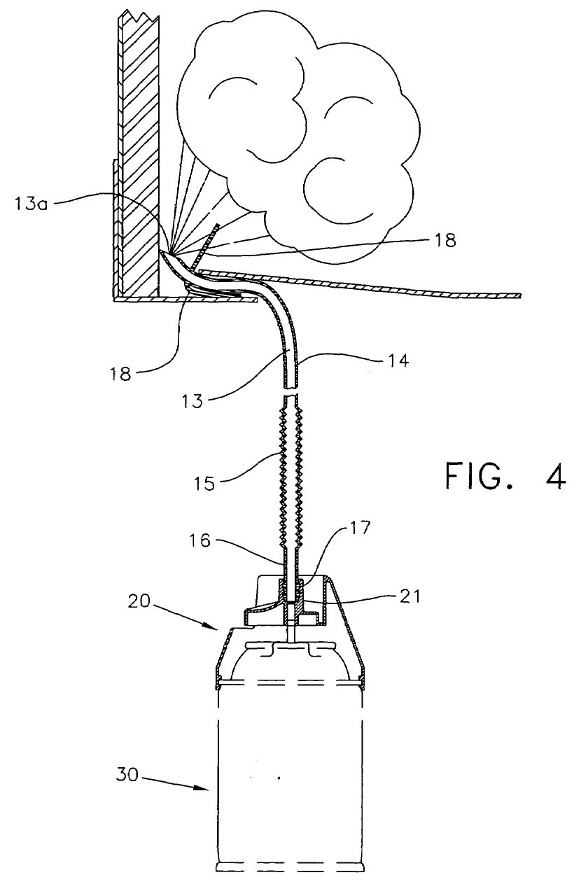

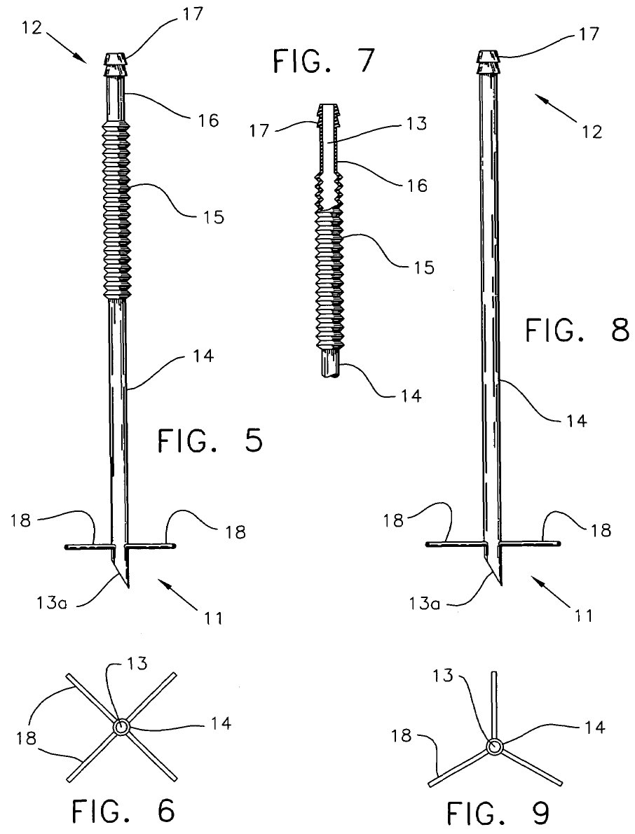

FIGS. 5, 6, and 7 detail a preferred embodiment of the extended discharge tube 10. The embodiment contains a multiplicity of radial striations 17 intended to interlock with a mating shape 21, shown in FIG. 1. Though this connection provides for secure attachment of the two pieces, the design also allow for orthodox utilization of the conventional portion of the total release actuator 20, provided the extended discharge tube 10 is not installed. The corrugated portion 15 is a hollow accordion shaped portion of the discharge tube 10, which provides improved flexibility of the discharge tube. This added flexibility ensures that the weight of the aerosol can 30 will result in bending of corrugated portion 15 and maintain upright attitude of aerosol can 30 to facilitate complete discharge of stored pressurized contents, when the total release actuator 20 is triggered. The proximal tubular portion 16 is congruent with and located between the attachment end 12 and corrugated portion 15. Increased rigidity of the proximal tubular portion 16, relative to the corrugated portion 15 facilitates installation of the attachment end 12 to mating shape 21 on the total release actuator cap 20. The distal tubular portion 14 is congruent with and located between the corrugated portion 15 and discharge end 11. The smoother exterior and increased rigidity of the distal tubular portion 14, relative to corrugated portion 15, provides for easy positioning of the discharge end 11 within a confined space, best shown in FIG. 4.

Relative stiffness of distal tubular portion 14 is sufficient to allow effective pushing or fishing of the tubular section 14 around enclosed corners, as shown in FIG. 4. However, the tubular portion 14 is flexible enough to allow a 90 degree centerline bend radius of approximately ¼ inch, yet resilient enough to prevent collapsing of the interior hollow cavity 13 while doing so. The preferred embodiment of the inventive extended discharge tube 10, best shown in FIG. 1, contains a hollow cavity 13, cross-sectional dimension of approximately ⅛ inch diameter and an outside diameter of the tubular portion 14 of approximately 3/16 inch diameter. It should be noted that dimensions mentioned herein are for general reference only and variations from these dimensions may prove equally effective provided the overall premise of the invention is preserved.

Continuing with the review of FIGS. 5 and 6 of the preferred embodiment, the discharge end 11 is axially disposed opposite the attachment end 12 and contains a discharge opening 13a and at least one, but preferably a plurality of barbs 18. The discharge opening 13a is the termination point of the hollow cavity 13 at the discharge end 11 and serves as a vent for final exhaust of expelled contents of the aerosol canister 30. The barb(s) 18 consist of relatively thin radially disposed protruding members located in close proximity to the discharge end 11. The barb(s) 18 project approximately perpendicular to and extend radially from the distal tubular portion 14 approximately ¾ inch, as shown in FIG. 6. As best illustrated in FIG. 4, the barbs 18 are flexible enough to fold axially in both directions along the length of the distal tubular portion 14 without breaking, but are resilient enough to spring back near perpendicular once all forces are removed. In addition the perpendicular bias of the barbs 18 is sufficient to support the weight of a full aerosol canister 30 without collapsing the barbs 18 axially.

One acceptable alteration to the preferred embodiment described above, best illustrated in FIG. 8, eliminates the corrugated portion 15 from the discharge tube 10 and in effect utilizes a continuous tubular portion 14 between attachment end 12 and discharge end 11.

Another acceptable alteration to the preferred embodiment described previously, best illustrated in FIGS. 8 and 9, contains only three (3) barbs 18 near the discharge end 11. It should be noted that quantity, size, length and shape of the barbs 18 are all subject to minor variations from the illustrations contained herein, as long as the functionality of the barbs is not compromised.

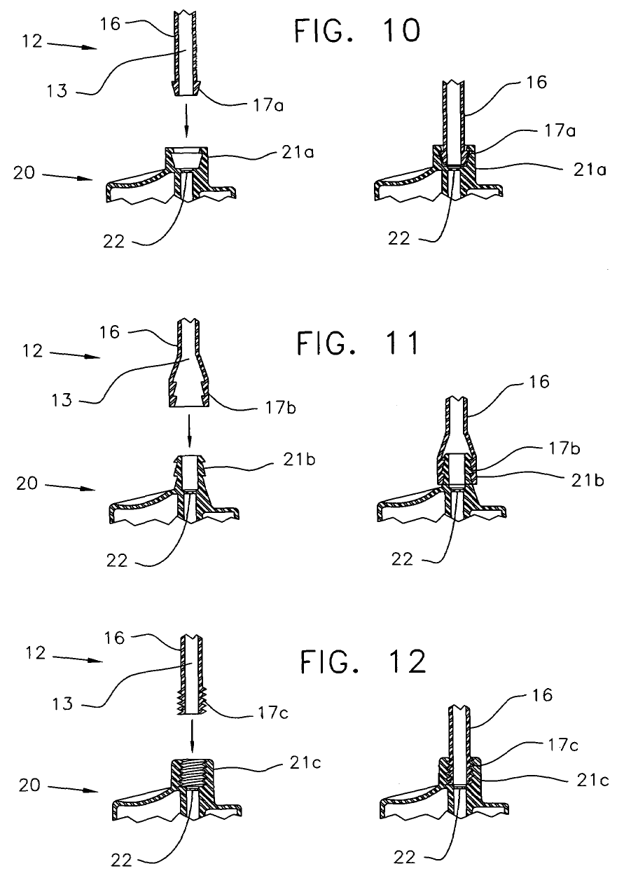

Another acceptable alteration to the preferred embodiment described previously, best illustrated in FIGS. 10, 11, and 12, the shape of attachment end 17 and its accepting shape 21. FIG. 10 illustrates an external single radial striation 17a versus the multiplicity of external striations 17 shown in FIG. 1. Internal striations 17b which mate with exterior striations 21b, best shown in FIG. 11, form another acceptable alteration to the design. Threads are also an acceptable means of attachment. FIG. 12 shows a threaded attachment end 17c and mating threaded portion 21c.

Despite allowable variations from the preferred embodiment, the attachment end 12 is equipped with some form of radial projections, indentions or a combination of the two which mate with an adapted total release actuator 20 to provide a locking or removably secured connection, which creates a continuous path 13 for discharge of the pressurized contents of the aerosol canister, shown in phantom generally at 30, to the discharge end 11 of the elongated discharge tube 10. Whether the chosen embodiment consists of interlocking indentions or mating threaded portions the result is a connection that seals the discharge tube 10 to the total release actuator 20 in such a way to provide a robust connection capable of supporting the weight of a full aerosol canister 30 in conjunction with thrust forces normally associated with discharge of aerosol spray through a narrow tube.

Preferred embodiments of the extended discharge tube 10 lend themselves to single piece molding from resilient yet flexible plastics. Processes for molding of similar shapes are know and are proven for efficiently and economical manufacture of such pieces. The acceptable modifications to known total release actuators, depicted as 17, 17a, 17b, and 17c in FIGS. 1, 10, 11, and 12 respectively, also lend themselves to conventional molded plastic construction.

While the preferred embodiments of the invention have been described above, it will be recognized and understood that various modifications may be made in the invention and the appended claims are intended to cover all such modification which may fall within the spirit and scope of the invention.

Having described my invention with the particularity set forth above, what is claimed is:

1. An improvement to known total release insecticidal foggers, normally used in conjunction with aerosol canisters for uninterrupted discharge of canister contents, providing an integral extended discharge tube for remote application of the insecticidal fog to the interior of a confined space.

2. The extended discharge tube in claim 1 having a minimum of one radially disposed protrusion flexible enough to fold axially along the length of the discharge tube yet resilient enough to support the weight of a fully charged aerosol canister.

3. The extended discharge tube in claim 2 having an accordion shaped portion which provides the tube with improved flexibility, thereby ensuring upright attitude of the aerosol canister is maintained when the weight of the canister is suspended by said tube.

4. An improvement to known total release actuators, normally used in conjunction with aerosol type canisters for uninterrupted discharge of pressurized contents, which provides a means for permanently or removably attaching an extended discharge tube for remote application of the contents of the canister.

5. A single piece extended discharge tube with a means for permanent or removable attachment to the modified total release actuator of claim 4.

6. The extended discharge tube in claim 5 having a minimum of one radially protrusion which is flexible enough to fold axially along the length of the discharge tube yet resilient enough to support the weight of a fully charged aerosol canister.

7. The extended discharge tube in claim 6 having an accordion shaped portion which provides the tube with improved flexibility to ensure upright attitude of the aerosol canister is maintained when the weight of the canister is suspended by said tube.
